(19) United States
(12) Patent Application Publication
(10) Pub. No.: US 2023/0129695 A1
(43) Pub. Date: Apr. 27, 2023

(54) UPDATING OF DATA STRUCTURES

(71) Applicant: SAP SE, Walldorf (DE)

(72) Inventors: Wulf Kruempelmann, Altlussheim (DE); Susanne Schott, Walldorf (DE)

(21) Appl. No.: 17/452,380

(22) Filed: Oct. 26, 2021

(51) Int. Cl. G06F 16/23

(52) U.S. Cl. CPC G06F 16/2379

(57) ABSTRACT

A method, a system, and a computer program product for updating data included in one or more data structures stored in one or more database systems. A request to update at least a portion of data included in the data structures is received. One or more keys associated with the data in the received request are identified. One or more triggering components are generated using the identified keys. The triggering components prevent execution of the update in the received request to all data in the data structures. The update to at least a portion of data identified by the identified keys is executed using the generated triggering components. The data structures including the updated portion of data are stored in the database systems.

### TECHNICAL FIELD

This disclosure relates generally to data processing and, in particular, to updating of data tables/structures in computing systems.

### BACKGROUND

Database management systems have become an integral part of many computer systems. For example, some systems handle hundreds if not thousands of transactions per second. On the other hand, some systems perform very complex multidimensional analysis on data. In both cases, the underlying database may need to handle responses to queries very quickly in order to satisfy systems requirements with respect to transaction time. Data stored by such systems may be stored using various schemas. Such data may be stored in tables, some of which may periodically be updated. Given the complexity of updates, volume of data stored, and/or their volume, the underlying databases face challenges in order to optimize performance and provide access to data.

### SUMMARY

In some implementations, the current subject matter relates to a computer implemented method for updating data included in one or more data structures stored in one or more database systems. The method may include receiving a request to update at least a portion of data included in one or more data structures stored in one or more database systems, identifying one or more keys associated with the data in the received request, and generating, using the identified keys, one or more triggering components. The triggering components may prevent execution of the update in the received request to all data in the data structures. The method may further include executing, using the generated triggering components, the update to the at least a portion of data identified by the identified keys, and storing the data structures including the updated portion of data in the database systems.

In some implementations, the current subject matter may include one or more of the following optional features. The triggering components may include one or more instead-of-trigger components (e.g., that may include identification of keys in one or more of its SELECT statements, as discussed above). In some implementations, the execution of the update may include deleting the triggering components subsequent to the executing of the update to the portion of data.

In some implementations, the data structures may include one or more tables stored in the database systems. The update may be executed using one or more external programs running after upgrade (XPRA) communicatively coupled to the database systems. Further, the execution of the update may include transporting the portion of data to the XPRA to execute the update in the received request. Moreover, the storing of the updated data table/structure may include receiving the updated portion of data being transported from the XPRA.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system for updating data tables/structures in computing systems, software applications, etc., according to some implementations of the current subject matter;

FIG. 2 illustrates an exemplary transformation process;

FIG. 3 illustrates an exemplary system for performing an update to a data table/structure in a database, according to some implementations of the current subject matter;

FIG. 4 illustrates an exemplary process for updating data stored in the database, according to some implementations of the current subject matter;

FIG. 5 illustrates an exemplary system, according to some implementations of the current subject matter; and

FIG. 6 illustrates an exemplary method, according to some implementations of the current subject matter.

### DETAILED DESCRIPTION

To address the deficiencies of currently available solutions, one or more implementations of the current subject matter provide for an ability to updating data tables/structures in computing systems.

Database management systems and operations performed on the data managed by a database management system have become increasingly complex. For example, a database management systems (or database for short) may support relatively complex online analytical processing (OLAP, which may perform multi-dimensional analysis) to more straightforward transaction-based online transaction processing (OLTP). Moreover, the database may be configured as a row store database or column store database, each of which may have certain aspects with respect to queries and other operations at the database. For example, the database may encode data using dictionaries, while some databases may not. In addition to these various databases layer differences, the queries performed at a database may include a complex sequence of operations in order to generate corresponding responses. To implement the complex sequence, a query execution plan (or query plan for short) may be implemented. The query plan may represent a sequence of operations, such as instructions, commands, and/or the like, to access data in the database. The database may also include a query plan optimizer to determine an efficient way to execute the query plan.

From an application or client perspective, it may be extremely cumbersome to access databases. For example, an application may need to query different types of databases using complex queries. As a consequence, the application layer may need to be configured to handle the various types of databases and various query types. Additionally or alternatively, each database may need to process queries from the application into a format and structure that can be handled by the given database. Pushing complex operations and support for a variety of different database types to the application layer may contravene the need to have relatively lighter weight and/or readily deployable applications. On the other hand, pushing complex operations to the database layer where data is stored may draw processing and/or memory resources at the database and may thus reduce the performance and response times for queries on that database layer.

File storage and/or processing systems may be centralized using of one or more servers, which can offload processing and/or storage from client devices accessing the one or more servers. However, although servers may make it easier and/or more convenient for users to store/access data from virtually anywhere, servers may still only have a limited processing and/or storage capacity (e.g., a server or set of servers may only be able to process so many things at one time without degrading performance). Hence, owners/operators of servers may wish to optimize processing procedures performed at the servers. Thus, at least some of the subject matter described herein relates to systems and methods for managing, storing, and/or accessing data in a document store. As used herein, data may refer to semi-structured data, electronic documents such as JSON documents, and/or the like.

When a table structure in a database (e.g. a database managed by a database management system or DBMS) undergoes a significant change, a typical approach involves a table conversion. In other words, a table of the target structure is generally created and filled with all data stored in columns with the same name in both the original structure and the new structure. Next, new columns are filled with default values before the old table is dropped and the new table is renamed to the original table name. An external program running after upgrade (XPRA) or other data migration programs may work on the preserved and new columns.

Such an approach can have some inefficiencies. For example, temporary data duplication results from creation of the new table and migration of data from the original table. Additionally, data of renamed or deleted columns may be lost in the end and cannot be accessed during the conversion process. Further, data duplication of very large tables is desirably avoided, particularly in an in-memory database environment in which expensive main memory is used for data storage and manipulation, but also in other database environments due to performance issues. The potential for data loss is generally unacceptable in any environment.

Moreover, upgrading a database application (e.g., an application running in an enterprise resource management system or other software architecture) may require a change of a table structures. Simple structure changes may result in executions of data definition language (DDL) statements on the database, and may generally have a small memory footprint, and rather short runtimes. In contrast, complex structure changes generally cannot be performed directly on the database level, for example because they result in a conversion of a table. Complex structure changes such as this may require that data are copied from the original table with the old structure (also referred to as original table A) into a new table with the new structure (referred to as table A′). Afterwards table A is dropped, and table A′ is renamed to A.

A conversion to implement a structural change performed using previously available approaches can result in long runtimes and large space requirements. Thus, some database management system may prohibit significant changes to a table structure for tables holding large amounts of data. Under such a prohibition, structural changes may be avoided by creating new columns as additions to the table but without dropping the old ones. However, this type of workaround generally requires that the application logic address the added table complexity, which can result in less than optimal performance.

Avoidance or reduction of such poor table structures can require implementation of significant structural change, which, as noted above, can result in long runtimes, temporary data duplication, or (in very undesirable cases) data loss if such changes are performed using conventional approaches.

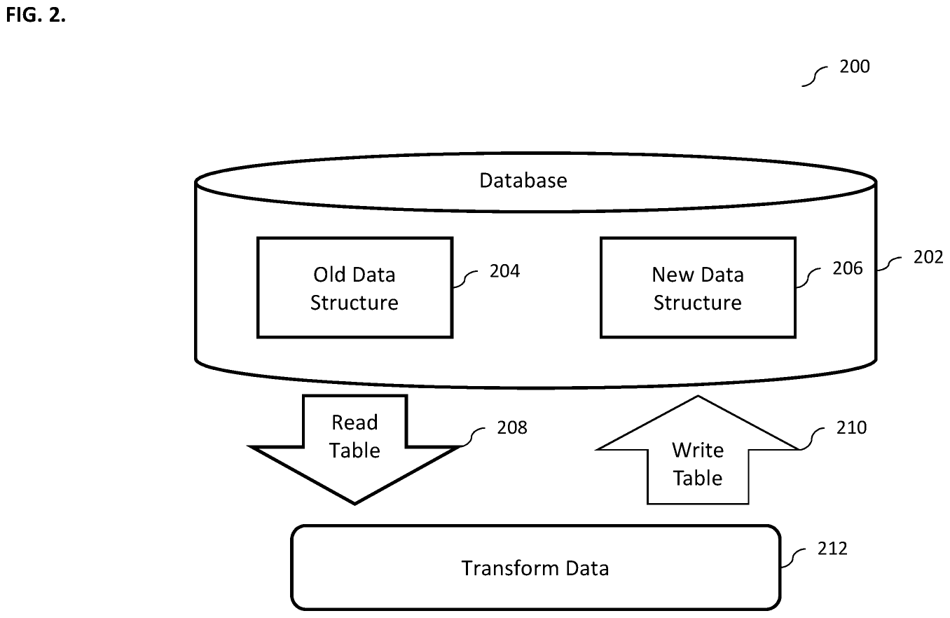

Further, during a software upgrade, various programs and/or applications can be used to change data from old data structures (e.g., old data tables) to new data structures (e.g., new data tables). Some of these programs may include external programs running after upgrade (XPRAs) can be implemented for such purposes. Typically, for conversion of data structures, the programs/applications can read an entire old data table/structure, perform a transform of the old data table/structure into a new data table/structure, and then store the new data table/structure in the database. This transformation process is shown in FIG. 2.

As shown in FIG. 2, a conversion system 200 may include a database 202 and a transform data component 212. The transform data component 212 may include one or more external programs running after upgrade (XPRAs). The conversion process may be initiated by the transform component 212 by reading, at 208, an old data table/structure 204. The old data table/structure 204 may include previous version of data table/structure (e.g., prior to update, insertion, deletion, etc. of data and/or any software applications that may use, rely, access, etc. that data). The transform data component 212 may then execute a transformation of the old data table/structure. The transformation may include updating the data stored in the old data table/structure 204 (e.g., by updating, modifying, deleting, inserting, etc. any data). The component 212 may then write a new data table/structure 206, at 210, and store it in the database 202.

The data tables/structure may be quite large and contain significant amounts of data, not all of which may be affected by an update. Thus, only a portion of old data table/structure needs to be updated. However, conventional systems typically require reading of an entire old data table/structure to perform an update to only a portion of that table. They are not able to perform a limited number of updates to the table.

In some implementations, the current subject matter may be configured to address the above issues by executing an update to select portions of previous versions of data tables/structures without having to read the entire previous version of the data table/structure. This may be accomplished through use of one or more filters that may be used to determine which data has been updated in the previous version of the data table/structure. One or more instead-of-triggers may be used to accomplish this task.

Instead-of-triggers may be special stored procedures that may be configured to override a default action of a triggering statement (e.g., INSERT, UPDATE, DELETE, etc.), and perform one or more user-defined actions. The instead-of-trigger may be configured to be executed each time a data modification statement executes on a specific view. A single instead-of-trigger may be configured to apply to one specific triggering action and/or may apply to multiple actions, in which the same trigger may be configured to execute all listed actions. Further, instead-of-triggers may be configured to use one or more logical inserted and/or deleted tables to store one or more modified records while the trigger is active. Each column in these tables may be configured to map directly to a column in a base view referenced in the trigger. For example, if a view named V₁ includes columns named C₁, C₂, and C₃, the inserted and/or deleted tables contain values for all of these columns, even if the trigger modifies only column C₂. Further, an instead-of-trigger may be configured to be executed only once per data modification statement. A query containing a WHILE loop may repeat an update and/or insert such data modification statement many times, thereby executing the instead-of-trigger each time.

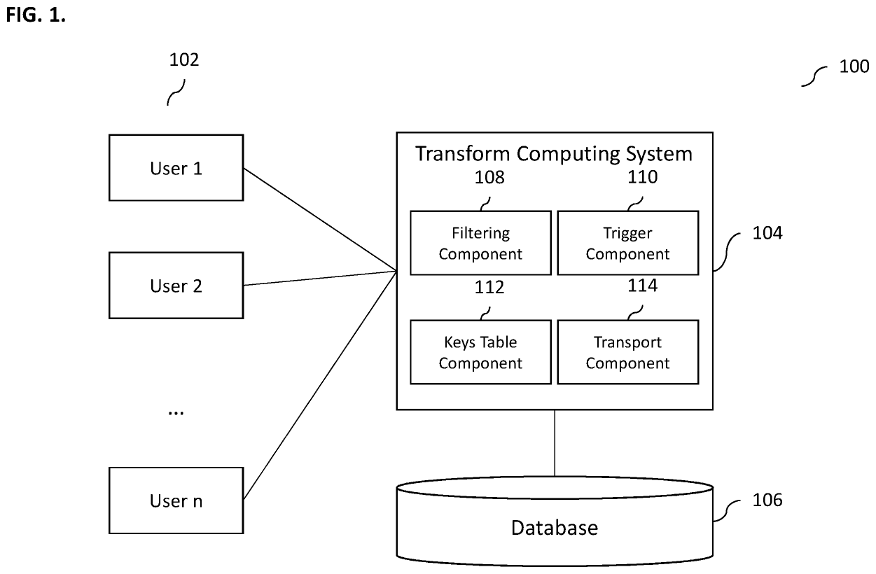

FIG. 1 illustrates an exemplary system 100 for updating data structures in computing systems, software applications, etc., according to some implementations of the current subject matter. The system 100 may be configured to operate in one or more database system environments, cloud computing environments, clustered computing environments (e.g., Kubernetes), and/or any other computing environments. It may include one or more users, entities, applications, etc. 102 (e.g., user 1, user 2, . . . , user n, etc.), a transform computing system and/or engine 104, and a database 106. The system 104 may include one or more filtering components 108, one or more trigger components 110, one or more key table components 112, and one or more transport components 114.

The computing system/engine 104 may include a processor, a memory, and/or any combination of hardware/software, and may be configured to perform an update to data structures. Components of the system 100 may be communicatively coupled using one or more communications networks. The communications networks can include at least one of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

The components of the system 100 may include any combination of hardware and/or software. In some implementations, the components may be disposed on one or more computing devices, such as, server(s), database(s), personal computer(s), laptop(s), cellular telephone(s), smartphone(s), tablet computer(s), and/or any other computing devices and/or any combination thereof. In some implementations, the components may be disposed on a single computing device and/or can be part of a single communications network. Alternatively, the components may be separately located from one another.

The database 106 may be used to store various data arranged in one or more tables. The stored data may be modified and/or updated, by way of a non-limiting example, through one or more data manipulation language (DML) processes, which may include one or more operations, including but not limited to, INSERT (e.g., insertion of data into an existing data at a predetermined offset or location), UPDATE (e.g., modification of stored data), and DELETE (e.g., deletion of stored data). Additionally, for example, the stored data may be affected using various data definition language (DDL) statements, which may include creation of various schema for data storage. In some implementations, the database system 106 may include one or more servers, processors, memory locations, cloud computing components/systems, etc. that may be used for accessing data.

The database table(s) may include at least one column, which may be accessed by the system 104. The database table(s) may store any kind of data. For example, the data may include, but is not limited to, definitions of business scenarios, business processes, and one or more business configurations as well as transactional data, metadata, master data, etc. relating to instances or definitions of the business scenarios, business processes, and one or more business configurations, and/or concrete instances of data objects and/or business objects that are relevant to a specific instance of a business scenario, business process, and/or the like.

In some implementations, the system 100 (and/or any portion thereof) may be implemented as a cloud-based database management system (e.g., not including the user devices 102). A cloud-based database management system may be a hardware and/or software system for receiving, handling, optimizing, and/or executing database system 106 queries. The database 106 may be a structured, organized collection of data, such as schemas, tables, queries, reports, views, and/or the like, which may be processed for information. Further, the database system 106 may be physically stored in a hardware server or across a plurality of hardware servers. A cloud-based database management system may be a hardware and/or software system that interacts with a database, document store, users, and/or other software applications for defining, creating, and/or updating data, for receiving, handling, optimizing, and/or executing database queries, and/or for running applications which utilize the database 106.

In some implementations, the system/engine 104 may be configured to receive an indication from one or more users 102 regarding an update to one or more data structures (e.g., a portion of data contained within a particular data structure) that may be stored in the database 106. In response to the user's indication, the system/engine 104 may be configured to identify and read the data structure which needs to be updated. A transport component 114 may be used to transport the identified data structure from the database 106. A filtering component 108 may be configured to filter the identified data structure being transported from the database 106. The filtering component 108 may be configured to use one or more parameters, keys, etc. associated with the update to filter the identified data structure. The parameters, keys, etc. may be imported into and stored by the key table component 112. The trigger component 110, using the filtering parameters, keys, etc. stored by the keys table component 112, may be configured to prevent transport of data in the identified data structure to which update is not being performed. This way, the system 104 may be configured to distinguish between general data contained in the identified data structure and any new updated data.

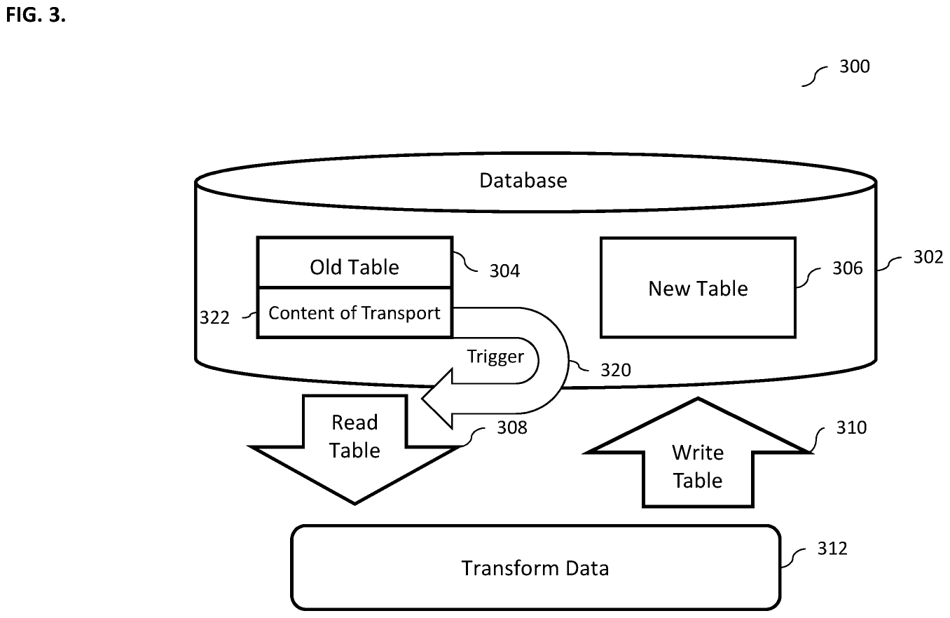

FIG. 3 illustrates an exemplary system 300 for performing an update to a data table/structure in a database, according to some implementations of the current subject matter. The system 300 may include a database 302 and a transform data component 312. The database 302 may be similar to the database 106 shown in FIG. 1. The transform data component 312 may be similar to the transform data component 114 shown in FIG. 1 and may include one or more external programs running after upgrade (XPRAs). The data table/structure update process may be initiated by the transform component 312 by reading, at 308, an old data table/structure 304. The old data table/structure 304 may include previous version of data table/structure (e.g., prior to update, insertion, deletion, etc. of data and/or any software applications that may use, rely, access, etc. that data). The transform data component 312 may then execute a transformation of the old data table/structure. The transformation may include updating the data stored in the old data table/structure 304 (e.g., by updating, modifying, deleting, inserting, etc. any data). The component 312 may then write a new data table/structure 306, at 310, and store it in the database 302.

As part of the update process, one or more trigger components 320 (similar to trigger components 110 shown in FIG. 1) may be used. The trigger component 320 may include an instead-of-trigger component. The instead-of-trigger component 320 may rely on the information contained in the content of transport component 322 (e.g., data keys corresponding to the update to the data table/structure 304 that may be stored in the keys table component 112 shown in FIG. 1). The instead-of-trigger component 320 may be used from the database 302 and can be generated as a result of a transport request for transporting the data table/structure for an update using the transform data component 304. Further, in some exemplary implementations, the instead-of-trigger component may be generated on a SELECT condition that may be included in the transport request. The following code may be used for these purposes:

```
If transport-request is set
  SELECT from Table_old where key is in [list of transport keys from
  transport request] an [select condition]
Else
  SELECT from Table_old where [select condition]
End if
```

The SELECT condition may be used to access previous data table/structure that may require an update using one or more keys corresponding to the data values to be updated. The keys may be identified in the transport request that may be received (e.g., by the system 100 shown in FIG. 1).

Once transformation (e.g., update to the data using XPRA) is executed, the updated data table/structure may be stored in the database as table/structure 306. The instead-of-trigger may then be deleted.

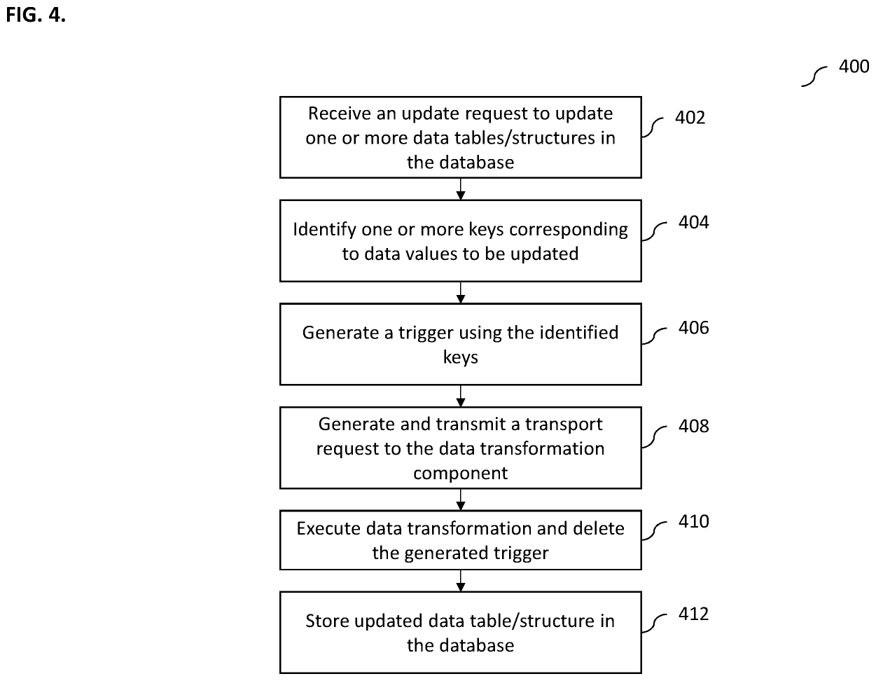

FIG. 4 illustrates an exemplary process 400 for updating data stored in the database, according to some implementations of the current subject matter. The process 400 may be executed using the systems 100 and/or 300 shown in FIGS. 1 and 3, respectively. At 402, a request to update one or more data tables/structures (e.g., table/structure 304 stored in the database 302 shown in FIG. 3) may be received.

At 404, one or more keys corresponding to data values (or any other programs, functionalities, etc.) contained in the table/structure 304 may be identified using the received request to update. As can be understood, any other ways of identifying data to be updated may be used. At 406, a trigger (e.g., an instead-of-trigger) may be generated using the identified keys. As stated above, the instead-of-trigger may be generated using the SELECT condition identifying the keys corresponding to data values to be updated.

At 408, the transport request may be transmitted to the data transformation component 312 to perform the update to the data values identified by the keys in the transport request. At 410, the data transform may be executed and the generated instead-of-trigger may be deleted, at 412. The updated data/structure 306 may be stored in the database 302.

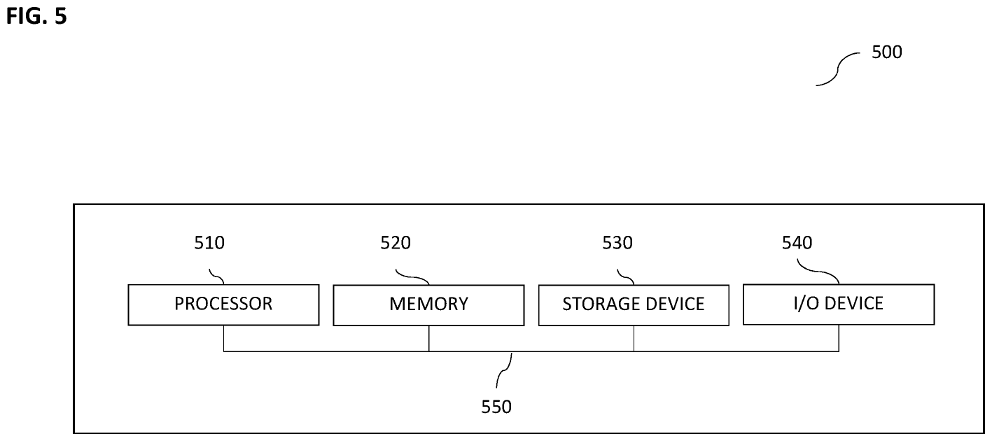

In some implementations, the current subject matter can be configured to be implemented in a system 500, as shown in FIG. 5. The system 500 can include a processor 510, a memory 520, a storage device 530, and an input/output device 540. Each of the components 510, 520, 530 and 540 can be interconnected using a system bus 550. The processor 510 can be configured to process instructions for execution within the system 500. In some implementations, the processor 510 can be a single-threaded processor. In alternate implementations, the processor 510 can be a multi-threaded processor. The processor 510 can be further configured to process instructions stored in the memory 520 or on the storage device 530, including receiving or sending information through the input/output device 540. The memory 520 can store information within the system 500. In some implementations, the memory 520 can be a computer-readable medium. In alternate implementations, the memory 520 can be a volatile memory unit. In yet some implementations, the memory 520 can be a non-volatile memory unit. The storage device 530 can be capable of providing mass storage for the system 500. In some implementations, the storage device 530 can be a computer-readable medium. In alternate implementations, the storage device 530 can be a floppy disk device, a hard disk device, an optical disk device, a tape device, non-volatile solid state memory, or any other type of storage device. The input/output device 540 can be configured to provide input/output operations for the system 500. In some implementations, the input/output device 540 can include a keyboard and/or pointing device. In alternate implementations, the input/output device 540 can include a display unit for displaying graphical user interfaces.

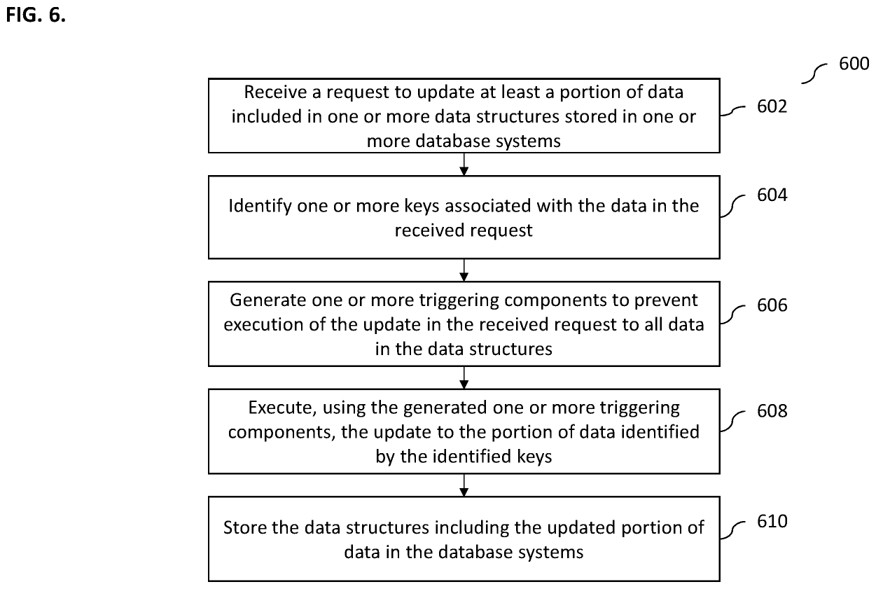

FIG. 6 illustrates an exemplary method 600 for updating data included in one or more data tables/structures stored in one or more database systems, according to some implementations of the current subject matter. The method 600 may be executed by the system 100 (shown in FIG. 1) and/or system 300, as shown in FIG. 3. The method 600 may implement the techniques discussed above in connection with FIGS. 1-5.

At 602, a request to update at least a portion of data included in one or more data structures stored in one or more database systems may be received. For example, the request may be received by the system 104 shown in FIG. 1. The request may be from a user and/or as a result of an update to data, software application, etc. and/or from any other source.

At 604, one or more keys associated with the data in the received request may be identified. The keys may correspond to specific data values in the data tables/structures that may need to be updated.

At 606, one or more triggering components or triggers may be generated using the identified one or more keys (e.g., using the SELECT statement, as discussed above). The triggering components may be configured to prevent (or otherwise, filter) execution of the update in the received request to all or entire data stored in the data structures.

At 608, the update to the portion of data identified by the keys may be executed using the generated triggering components. For example, the update may be transported to a data transform component 312 shown in FIG. 3, which may include XPRA.

At 610, the data structures including the updated portion(s) of data may be stored in the database systems (e.g., database 104, 302, as shown in FIGS. 1 and 3, respectively).

In some implementations, the current subject matter may include one or more of the following optional features. The triggering components may include one or more instead-of-trigger components (e.g., that may include identification of keys in one or more of its SELECT statements, as discussed above). In some implementations, the execution of the update may include deleting the triggering components subsequent to the executing of the update to the portion of data.

In some implementations, the data structures may include one or more tables stored in the database systems. The update may be executed using one or more external programs running after upgrade (XPRA) communicatively coupled to the database systems. Further, the execution of the update may include transporting the portion of data to the XPRA to execute the update in the received request. Moreover, the storing of the updated data table/structure may include receiving the updated portion of data being transported from the XPRA.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
receiving a request to update at least a portion of data included in one or more data structures stored in one or more database systems;
identifying one or more keys associated with the data in the received request;
generating, using the identified one or more keys, one or more triggering components, the triggering components preventing execution of the update in the received request to all data in the one or more data structures;
executing, using the generated one or more triggering components, the update to the at least a portion of data identified by the identified one or more keys; and
storing the one or more data structures including the updated at least a portion of data in the one or more database systems.

2. The method according to claim 1, wherein the one or more triggering components include one or more instead-of-trigger components.

3. The method according to claim 1, wherein the executing including deleting the one or more triggering components subsequent to the executing of the update to the at least a portion of data.

4. The method according to claim 1, wherein the one or more data structures include one or more tables stored in the one or more database systems.

5. The method according to claim 1, wherein the update is executed using one or more external programs running after upgrade (XPRA) communicatively coupled to the one or more database systems.

6. The method according to claim 5, wherein the executing further comprising transporting the at least a portion of data to the XPRA to execute the update in the received request.

7. The method according to claim 6, wherein the storing further comprising receiving the updated at least a portion of data being transported from the XPRA.

8. A system comprising:
at least one programmable processor; and
a non-transitory machine-readable medium storing instructions that, when executed by the at least one programmable processor, cause the at least one programmable processor to perform operations comprising:
receiving a request to update at least a portion of data included in one or more data structures stored in one or more database systems;
identifying one or more keys associated with the data in the received request;
generating, using the identified one or more keys, one or more triggering components, the triggering components preventing execution of the update in the received request to all data in the one or more data structures;
executing, using the generated one or more triggering components, the update to the at least a portion of data identified by the identified one or more keys; and
storing the one or more data structures including the updated at least a portion of data in the one or more database systems.

9. The system according to claim 8, wherein the one or more triggering components include one or more instead-of-trigger components.

10. The system according to claim 8, wherein the executing including deleting the one or more triggering components subsequent to the executing of the update to the at least a portion of data.

11. The system according to claim 8, wherein the one or more data structures include one or more tables stored in the one or more database systems.

12. The system according to claim 8, wherein the update is executed using one or more external programs running after upgrade (XPRA) communicatively coupled to the one or more database systems.

13. The system according to claim 12, wherein the executing further comprising transporting the at least a portion of data to the XPRA to execute the update in the received request.

14. The system according to claim 13, wherein the storing further comprising receiving the updated at least a portion of data being transported from the XPRA.

15. A computer program product comprising a non-transitory machine-readable medium storing instructions that, when executed by at least one programmable processor, cause the at least one programmable processor to perform operations comprising:
receiving a request to update at least a portion of data included in one or more data structures stored in one or more database systems;
identifying one or more keys associated with the data in the received request;
generating, using the identified one or more keys, one or more triggering components, the triggering components preventing execution of the update in the received request to all data in the one or more data structures;
executing, using the generated one or more triggering components, the update to the at least a portion of data identified by the identified one or more keys; and
storing the one or more data structures including the updated at least a portion of data in the one or more database systems.

16. The computer program product according to claim 15, wherein the one or more triggering components include one or more instead-of-trigger components.

17. The computer program product according to claim 15, wherein the executing including deleting the one or more triggering components subsequent to the executing of the update to the at least a portion of data.

18. The computer program product according to claim 15, wherein the one or more data structures include one or more tables stored in the one or more database systems.

19. The computer program product according to claim 15, wherein the update is executed using one or more external programs running after upgrade (XPRA) communicatively coupled to the one or more database systems.

20. The computer program product according to claim 19, wherein
the executing further comprising transporting the at least a portion of data to the XPRA to execute the update in the received request; and
the storing further comprising receiving the updated at least a portion of data being transported from the XPRA.
